(19) United States
(12) Patent Application Publication
(10) Pub. No.: US 2026/0288621 A1
(43) Pub. Date: Sep. 24, 2026

(54) Data Processing Systems

(71) Applicant: Arm Limited, Cambridge (GB)

(72) Inventor: Nikunj Kaushik PATEL, Cambridge (GB)

(73) Assignee: Arm Limited, Cambridge (GB)

(21) Appl. No.: 19/572,776

(22) Filed: Mar. 19, 2026

(30) Foreign Application Priority Data
Mar. 24, 2025 (GB) 2504260.7

(51) Int. Cl. G06F 11/362

(52) U.S. Cl. CPC G06F 11/3644; G06F 11/3624

(57) ABSTRACT

A method of debugging a program is disclosed in which one or more sets of one or more instructions are inserted at one or more places in the program which, when executed by a data processor, cause the data processor to determine whether to pause execution of the program using information that indicates whether to continue executing the program without pausing, and when it is determined to pause execution of the program, pause execution of the program.

### BACKGROUND

The technology described herein relates to data processing systems, and in particular to program debugging in data processing systems, such as graphics processing systems.

A data processor may include hardware support for program debugging operations. In a data processor that does not include hardware support for program debugging operations, alternative ways to implement program debugging operations may be desirable.

The inventor believes that there remains scope for improvements to program debugging in data processing systems.

### BRIEF DESCRIPTION OF THE DRAWINGS

Embodiments will now be described by way of example only and with reference to the accompanying drawings, in which:

FIG. 1 illustrates an exemplary graphics processing system;

FIG. 2 illustrates exemplary operation of the graphics processing system of FIG. 1;

FIG. 3 illustrates an exemplary graphics processor;

FIG. 4 illustrates a debugging process in accordance with embodiments;

FIG. 5 illustrates in more detail a debugging process in accordance with embodiments;

FIG. 6 illustrates operation of a host processor in accordance with embodiments;

FIG. 7 illustrates a graphical user interface (GUI) of a debugger program in accordance with embodiments;

FIG. 8 illustrates an array of bits that indicates whether to continue executing a program without pausing in accordance with embodiments;

FIG. 9 illustrates pseudo-code for generating information that indicates whether to continue executing a program without pausing in accordance with embodiments; and

FIG. 10 illustrates pseudo-code for determining whether to pause execution of a program using information generated according to the pseudo-code of FIG. 9.

### DETAILED DESCRIPTION

A first embodiment of the technology described herein comprises a method of debugging a program for execution by a data processor; the method comprising:
inserting, at one or more places in a program, a set of one or more instructions that when executed by the data processor, will cause the data processor to:
   determine whether to pause execution of the program using information that indicates whether to continue executing the program without pausing; and
   when it is determined to pause execution of the program, pause execution of the program (for debugging the program);
the method further comprising:
the data processor executing the program, and in response to (reaching a place of the one or more places and) executing a (the respective) set of one or more instructions inserted into the program:
   determining whether to pause execution of the program using information that indicates whether to continue executing the program without pausing; and
   when it is determined to pause execution of the program, pausing execution of the program (for debugging the program).

A second embodiment of the technology described herein comprises a data processing system operable to debug programs; the data processing system comprising:
a processing circuit operable to provide programs for execution; and
a data processor operable to execute programs provided for execution by the processing circuit;
wherein the processing circuit is configured to:
insert, at one or more places in a program, a set of one or more instructions that when executed by the data processor, will cause the data processor to:
   determine whether to pause execution of the program using information that indicates whether to continue executing the program without pausing; and
   when it is determined to pause execution of the program, pause execution of the program (for debugging the program); and
wherein the data processor is configured to, in response to executing a set of one or more instructions inserted into a program by the processing circuit:
   determine whether to pause execution of the program using information that indicates whether to continue executing the program without pausing; and
   when it is determined to pause execution of the program, pause execution of the program (for debugging the program).

The technology described herein relates to debugging a (target) program. In the technology described herein, in order to facilitate debugging of a target program, one or more sets of one or more instructions are inserted at one or more places in the target program, wherein each set of one or more instructions can (when executed) cause a pause in execution of the target program, i.e. a breakpoint, e.g. to allow information about the state of the program during its execution to be obtained for debugging purposes. In embodiments, plural sets of one or more instructions are inserted into the target program at plural different places in the program, such that there are plural different places in the target program at which program execution can be suspended (and debugging information obtained).

In the technology described herein, rather than e.g. definitely causing a pause in program execution, a (each) set of one or more instructions that is inserted into the program (when executed) triggers a check of information that indicates whether to continue executing the program (after the (respective) set of one or more instructions) without pausing. In embodiments, a pause in program execution (a breakpoint) is then (only) caused when the information does not indicate that execution of the program should continue without pausing (e.g. when the information indicates that execution of the program should pause), and program execution continues without pausing when the information indicates that execution of the program should continue without pausing.

Thus, a (each) set of one or more instructions that is inserted into the program defines a “potential breakpoint” in the program at which program execution may or may not be paused for debugging purposes, depending on the information.

As will be discussed in more detail below, this can allow breakpoints to be implemented in a particularly flexible manner, with low processing overhead, and without providing hardware support for breakpoints.

For example, and in embodiments, a (each) set of one or more “potential breakpoint” instructions may be added into the target program (by the processing circuit) when the target program is being compiled for execution, i.e. before the target program is executed and before knowing where a pause in execution of the target program (a breakpoint) will actually be desired for debugging the target program.

Then, once the target program has been compiled for execution (by the processing circuit, e.g. compiler), and the compiled target program is executed by the data processor, whether or not a “potential breakpoint” in the program actually causes a pause in program execution can be selected by configuring the information appropriately.

Thus, by tightly coupling compile time and runtime operation, breakpoints can be implemented in a flexible and efficient manner, and without needing to provide hardware support. This can reduce silicon/area requirements for a data processor.

It will be appreciated therefore, that the technology described herein provides improved program debugging in data processors and data processing systems.

The data processor can be any suitable data processing unit that can execute program instructions (commands), such as a central processing unit (CPU) or a graphics processing unit (GPU). In embodiments, the data processor is a data processor that does not include hardware support for debugging operations, such as a data processor other than a central processing unit (CPU), such as a graphics processor (GPU). Thus, in embodiments, the data processor is a graphics processor (GPU) and the data processing system is a graphics processing system.

In embodiments, the data processor comprises one or more execution units that execute program instructions (commands), and the program is a program for execution by an execution unit of the data processor.

For example, and in embodiments, the data processor is a graphics processor (GPU) that comprises a command stream processor (command stream frontend (CSF)), and the program is a command stream program (comprising a sequence of commands) for execution by the command stream processor of the graphics processor (GPU).

In embodiments, the graphics processor (GPU) further comprises one or more further processing circuits in communication with the command stream processor, and the command stream processor is operable to distribute (graphics processing) tasks to the one or more further processing circuits in response to execution of a (command of) (the) command stream program. In embodiments, the command stream processor executes firmware that interprets commands of a (the) command stream program, and distributes tasks to the one or more further processing circuits accordingly.

The one or more further processing circuits of the graphics processor may, for example and in embodiments, comprise one or more processing cores (shader cores) operable to perform (graphics) processing operations by executing (e.g. shader) program instructions, and/or one or more geometry processing circuits operable to perform geometry processing operations, and/or one or more other (e.g. graphics processing) circuits.

In embodiments, the data (e.g. graphics) processor is part of a (the) data (e.g. graphics) processing system that also comprises a host processor, e.g. a central processing unit (CPU). The host processor (e.g. CPU) may execute applications that can require (e.g. graphics) processing by the data (e.g. graphics) processor, and send appropriate commands and data to the data (e.g. graphics) processor to control it to perform (e.g. graphics) processing operations and to produce (e.g. graphics) processing output required by applications executing on the host processor (e.g. CPU).

To facilitate this, the host processor (e.g. CPU) in embodiments also executes a driver for the data (e.g. graphics) processor. Thus, in embodiments, the data (e.g. graphics) processing system comprises a (the) data (e.g. graphics) processor that is in communication with a host microprocessor (e.g. CPU) that executes a driver for the data (e.g. graphics) processor. In embodiments, the processing circuit comprises or is the host processor (e.g. CPU).

The program may be provided in any suitable manner. In embodiments, the program is initially provided in a form that is not executable by (an execution unit (e.g. command stream processor) of) the data (e.g. graphics) processor, and is translated (compiled) into a form that is executable by (the execution unit (e.g. command stream processor) of) the data (e.g. graphics) processor. The program may be translated (compiled) using any suitable process, such as ahead-of-time compilation (AOT), just-in-time (JIT) compilation, etc.

In embodiments, an application executing on the host processor (e.g. CPU) (processing circuit) initially provides a program, e.g. comprising a sequence of API (Application Programming Interface) calls, which program is translated (compiled) into a form that can then be (and is) executed by (an execution unit (e.g. command stream processor) of) the data (e.g. graphics) processor.

The program may be translated (compiled) by any suitable processing element. In embodiments, the driver for the data (e.g. graphics) processor (that is executing on the host processor (e.g. CPU) (processing circuit)) is operable as (comprises) a compiler that receives and compiles the program, and provides the program in executable form for execution by (an execution unit (e.g. command stream processor) of) the data (e.g. graphics) processor.

A (each) set of one or more instructions can be inserted into the program in any suitable manner. A (each) set of one or more instructions should be, and in embodiments is, inserted into the program before the program is executed by the data (e.g. graphics) processor. In embodiments, a (each) set of one or more instructions is inserted into the program when (as part of) translating (compiling) the program for execution by the data (e.g. graphics) processor. Thus, in embodiments, the host processor (e.g. CPU)/processing circuit (e.g. driver/compiler) is operable to insert a (each) set of one or more instructions into the program when translating (compiling) the program for execution by the data (e.g. graphics) processor.

The one or more places in the program at which a (respective) set of one or more instructions is inserted can be selected in any suitable manner. In embodiments, a (each) set of one or more instructions is inserted into the program (before the program is executed) (by the processing circuit) (compiler) at a (respective) place in the program where a pause in execution of the program (a breakpoint) could be, e.g. is likely to be, e.g. is predicted to be, suitable for debugging the program. Thus, in embodiments, a (each) set of one or more instructions inserted into the program defines a (respective) “potential breakpoint” in

The program, i.e. a place in the program at which program execution may be paused for debugging the program.

Thus, in embodiments, one or more places in the program (at which a breakpoint for debugging the program could be desirable) are determined, and a (respective) set of one or more instructions is inserted into the program at (each of) the one or more determined places (before the program is executed) (by the processing circuit) (compiler).

The one or more “potential breakpoint” places for debugging the program can be determined in any suitable manner. One or more places may be determined manually, e.g. by a program developer, e.g. when writing the program. For example, a program developer may indicate one or more places in the program, e.g. by an appropriate comment or instruction added to the program (before the program is compiled for execution). Additionally or alternatively, one or more places may be determined automatically, e.g. by the processing circuit (e.g. compiler), e.g. when compiling the program for execution.

The one or more places in the program may, for example, correspond to one or more program features of interest, such as control flow, a jump, function call, loop, branch, synchronisation, etc., and/or the one or more places may correspond to regular intervals in the program, such as every N instructions (where N is a positive integer). Other arrangements are possible.

Only one set of one or more instructions may be included in the program at only one place in the program, but in embodiments there are plural different places in the program where a respective set of one or more instructions is included. Thus, in embodiments, the data (e.g. graphics) processor will check whether to pause program execution when execution of the program reaches plural different places in the program.

A (each) set of one or more instructions that is inserted into the program can comprise any suitable instruction(s) that will, when executed, cause the data (e.g. graphics) processor to check (determine) whether to pause program execution for debugging the program (using the information). A set of one or more instructions may comprise a single instruction that, when executed by itself, will trigger the data processor to check whether to pause program execution, or plural instructions that, when executed together, will trigger the data processor to check whether to pause program execution.

In embodiments, a (each) set of one or more instructions comprises a call to a function that is configured to determine whether to pause program execution for debugging the program. Thus, in embodiments, each set of one or more instructions inserted into the program comprises a call to the same function.

In embodiments, calls to the function are defined according to an ABI (Application Binary Interface). For example, the ABI may define a set of registers of the data processor for storing one or more pointers to the function, function parameter(s), the information, etc.

A (each) set of one or more instructions (e.g. function call), when executed, causes the data (e.g. graphics) processor to determine whether to pause execution of the program using information that indicates whether to continue executing the program without pausing. In embodiments, the information indicates whether to pause execution of the program.

In embodiments, the information indicates, for (each of) the one or more (determined) places in the program (at which a breakpoint for debugging the program could be desirable), whether to continue executing the program without pausing at the (respective) place and/or whether to pause execution at the (respective) place. Thus, in embodiments, the information indicates whether to “skip” a “potential” breakpoint in the program and/or whether to treat a “potential” breakpoint in the program as an “actual” breakpoint. In other words, in embodiments, the information indicates whether a (each) “potential” breakpoint is “disabled” (and so should not cause a pause) and/or whether a (each) “potential” breakpoint is “enabled” (and so should cause a pause).

The information can be provided in any suitable manner. In embodiments, the information is stored locally to (e.g. on the same chip as) the data (e.g. graphics) processor, e.g. in registers and/or cache and/or memory.

In embodiments, the information is configurable (e.g. by a user/developer), such that which of the one or more places at which program execution should continue without pausing and/or pause can be selected (e.g. by a user/developer). Thus, in embodiments, the information can be configured to indicate which “potential” breakpoint(s) in the program to skip and/or to treat as an “actual” breakpoint(s). In other words, in embodiments, the information can be configured to indicate which “potential” breakpoint(s) in the program are “disabled” (and so should not cause a pause) and/or “enabled” (and so should cause a pause).

Thus, in embodiments, zero or more of the one or more places at which a set of one or more instructions (e.g. function call) has been inserted into the program are selected (e.g. by a user/developer), and the information is configured to indicate which of the one or more places have been selected (e.g. by the user/developer).

In embodiments, metadata is generated (e.g. by the processing circuit (e.g. driver/compiler)) that describes each of the one or more places in the program that a set of one or more instructions (e.g. function call) has been inserted into the program, and the metadata is used (e.g. by the user/developer) when selecting zero or more of the one or more places. The metadata may, for example, comprise a (textual) description of each of the one or more places and/or corresponding feature of interest, and may e.g. be displayed to the user/developer (e.g. by a debugger program) to allow the user/developer to select zero or more of the one or more places.

The (configurable) information can take any suitable form. In embodiments, the information comprises a set (e.g. array) of one or more records that comprises, for each set of one or more instructions (e.g. function call) included in the program, a respective (configurable) record that indicates whether to continue executing the program without pausing and/or whether to pause execution of the program at the corresponding place in the program. Thus, in embodiments, executing a (each) set of one of more instructions (e.g. function call) causes the data processor to identify a record of a set of one or more (configurable) records, and determine whether to pause execution of the program using the identified record.

A record may be identified in any suitable manner. In embodiments, each set of one or more instructions (e.g. function call) that is included in the program is assigned a unique identifier (e.g. by the processing circuit (e.g. driver/compiler), e.g. when including the instructions in the program), and the unique identifier is used, when a set of one or more instructions (e.g. function call) is executed, to identify which record to use to determine whether to pause execution of the program.

In embodiments, the unique identifier is a parameter of the function. Thus, in embodiments, a (each) call to the function (inserted into the program) is associated with a unique identifier that is a parameter of the function, and the function is configured to determine whether to pause program execution based on the unique identifier. Thus, embodiments comprise the data processor (when executing the program) calling the function and passing a unique identifier to the function.

The unique identifier can take any suitable form. In embodiments, the unique identifier is an integer that starts from an initial value, such as zero, for a first set of one or more instructions (e.g. function call) included in the program, and increments, e.g. by one, for each subsequent set of one or more instructions (e.g. function call) included in the program. In embodiments, the set of one or more records is an array of one or more records, and each element of the array is identifiable (and identified) using the unique identifier as an index of the array.

A (each) record can take any suitable form. In embodiments, a (each) record comprises a (respective) flag, e.g. bit, that indicates whether to continue executing the program without pausing and/or whether to pause execution of the program. Thus, in embodiments, the information comprises a set (e.g. array) of one or more bits, wherein each bit of the one or more bits can take either a first value or a second value (e.g. zero or one). In embodiments, the set (e.g. array) of one or more bits includes as many bits as places in the program at which a set of one or more instructions (e.g. a function call) has been inserted, and each bit of the one or more bits corresponds to a respective place of the one or more places at which a set of one or more instructions (e.g. a function call) has been inserted into the program. Thus, in embodiments, the set of one or more bits includes a respective bit for each “potential breakpoint” defined in the program by a set of one or more instructions (e.g. function call).

In embodiments, a bit of the one or more bits having a first value (e.g. zero or one) indicates that execution of the program should continue without pausing (at the place in the program that the bit corresponds to). In embodiments, a bit of the one or more bits having a second value (e.g. one or zero) indicates that execution of the program should pause (at the place in the program that the bit corresponds to). Thus, in embodiments, a bit having a first value (e.g. zero) indicates that a “potential” breakpoint should be skipped, and in embodiments, a bit having a second value (e.g. one) indicates that a “potential” breakpoint should be treated as an “actual” breakpoint. In other words, in embodiments, a bit having a first value (e.g. zero) indicates that a corresponding “potential” breakpoint is “disabled” (and so should not cause a pause) and/or a bit having a second value (e.g. one) indicates that a corresponding “potential” breakpoint is “enabled” (and so should cause a pause).

Thus, in embodiments, a (each) set of one or more “breakpoint” instructions (e.g. function call) (when executed) causes the data processor to determine whether to pause execution of the program (at a particular place in the program) by determining whether a bit of the set (e.g. array) of one or more bits (that corresponds to the particular place in the program) has a first value or a second value. In embodiments, when it is determined that the bit has a first value (e.g. zero), it is determined that execution of the program should continue without pausing. In embodiments, when it is determined that the bit has a second value (e.g. one), it is determined that execution of the program should pause.

The determination of whether to pause program execution for debugging the program may only take into account whether a “potential” breakpoint in “enabled” or “disabled”. Thus, for example, a bit having a second value (e.g. one) could indicate unconditionally that program execution should pause. Alternatively, one or more further factors may be taken into consideration when determining whether to pause program execution. For example, and in embodiments, one or more further conditions may need to be satisfied before it can be (and is) determined that program execution should pause. To facilitate this, the information may (further) comprise further information that defines one or more further conditions which should be satisfied before it can be (and is) determined that program execution should pause.

Thus, in embodiments, when it is determined (by the data processor) that a bit has a second value (e.g. one), it is determined (by the data processor) whether one or more further conditions (defined by the further information) are satisfied, and it is determined (by the data processor) that execution of the program should pause (only) when it is determined that the one or more further conditions (for pausing the program) are satisfied.

The further information defining one or more further conditions can take any suitable form. In embodiments, the further information defines one or more further instructions that can be executed by the data processor and that will, when executed by the data processor, cause the data processor to determine whether the one or more further conditions are satisfied. In embodiments, the one or more further instructions are initially provided in a form that is not executable by the data processor, and are translated (compiled, e.g. just-in-time (JIT) compiled) into a form that is executable by the data processor (by the processing circuit, e.g. compiler/driver).

Thus, in embodiments, a (each) set of one or more instructions (e.g. function call) included in the program, when executed, can cause the data processor to determine whether to pause execution of the program by executing one or more further instructions that, when executed, cause the data processor to determine whether one or more further conditions are satisfied.

In embodiments, when it is determined (by the data processor) that execution of the program should continue without pausing, execution of the program (by the data processor) continues without pausing. A “potential” breakpoint defined in the program may thereby be skipped. In embodiments, when it is determined that execution of the program should pause, execution of the program is paused. A “potential” breakpoint defined in the program may thereby operate as an “actual” breakpoint.

A (each) pause in program execution (breakpoint) should be, and in embodiments is, a temporary interruption of program execution that e.g. has the potential for program execution to resume, and that e.g. allows information about a state of the program to be obtained for debugging purposes.

In embodiments, when program execution is paused, one or more debugging operations for debugging the program are performed. For example, and in embodiments, control may be passed (from the data (e.g. graphics) processor) to a debugger program, e.g. that is executing on the host processor (e.g. CPU) (processing circuit). The debugger program may, for example, request/obtain information indicative of a state of the program, and e.g. allow a user/developer to inspect the state of the program, etc. Other arrangements are possible.

In embodiments, once program execution has been paused (and one or more debugging operations for debugging the program have been performed), execution of the program (by the data (e.g. graphics) processor) may resume. For example, the debugger program may allow a user/developer to request that execution of the program resumes, and control may be passed back to the data (e.g. graphics) processor, etc. Alternatively, once program execution has been paused (and one or more debugging operations for debugging the program have been performed), program execution may stop.

The technology described herein also extends to including one or more “potential breakpoint” instructions in a program when compiling the program for execution.

Thus, another embodiment of the technology described herein comprises a method of debugging a program for execution by a data processor; the method comprising (when compiling the program for execution by the data processor):
inserting, at one or more places in the program, a set of one or more instructions that when executed by the data processor, will cause the data processor to:
   determine whether to pause execution of the program using information that indicates whether to continue executing the program without pausing; and
   when it is determined to pause execution of the program, pause execution of the program (for debugging the program).

Another embodiment of the technology described herein comprises an apparatus operable to provide programs for execution by a data processor; the apparatus configured to (when compiling a program for execution by the data processor):
insert, at one or more places in a program, a set of one or more instructions that when executed by the data processor, will cause the data processor to:
   determine whether to pause execution of the program using information that indicates whether to continue executing the program without pausing; and
   when it is determined to pause execution of the program, pause execution of the program (for debugging the program).

The technology described herein also extends to executing a compiled program into which one or more “potential breakpoint” instructions have been inserted.

Thus, another embodiment of the technology described herein comprises a method of debugging a program for execution by a data processor; the method comprising:
the data processor executing a program, and in response to executing a set of one or more instructions inserted into the program:
   determining whether to pause execution of the program using information that indicates whether to continue executing the program without pausing; and
   when it is determined to pause execution of the program, pausing execution of the program (for debugging the program).

Another embodiment of the technology described herein comprises a data processor operable to execute programs; the data processor configured to:
in response executing a set of to one or more instructions inserted into a program:
   determine whether to pause execution of the program using information that indicates whether to continue executing the program without pausing; and
   when it is determined to pause execution of the program, pause execution of the program (for debugging the program).

These embodiments can, and in embodiments do, include any one or more or all of the optional features described herein, as appropriate.

Each embodiment of the technology described herein can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the data/graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The graphics processor and/or graphics processing system may also comprise, and/or be in communication with, one or more memories and/or memory devices that store the data described herein, and/or store software (e.g. (shader) program) for performing the processes described herein. The processor and/or system may also be in communication with and/or include a host microprocessor, and/or with a display for displaying images based on data generated by the processor/system.

The technology described herein can be used for all forms of input and/or output that a graphics processor may use or generate. For example, the graphics processor may execute a graphics processing pipeline that generates frames for display, render-to-texture outputs, etc. The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the graphics processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

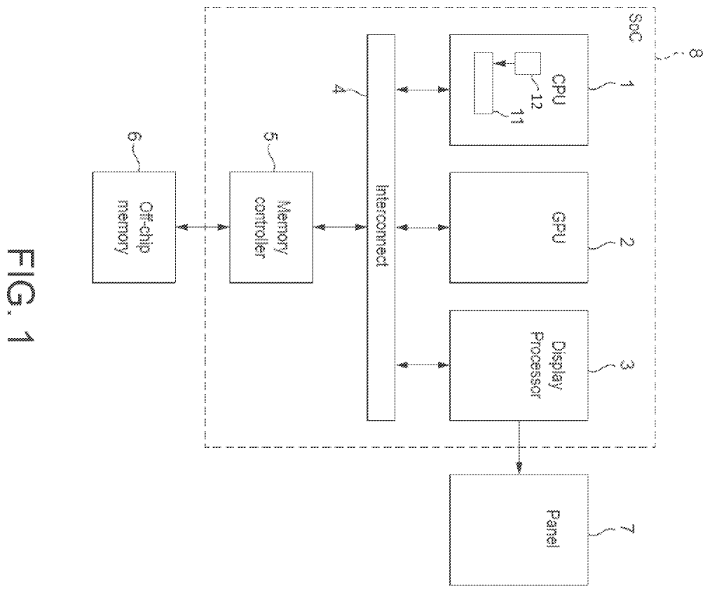

FIG. 1 shows an exemplary system on-chip (SoC) graphics processing system 8 that comprises a host processor in the form of a central processing unit (CPU) 1, a graphics processor (GPU) 2, a display processor 3 in communication with a display panel 7 of a display, and a memory controller 5. As shown in FIG. 1, these units can communicate via an interconnect 4 and have access to off-chip memory 6.

In use of this system, an application 12 such as a game, executing on the CPU 1 may require the display of frames (images) on the display panel 7. To do this, the application 12 submits appropriate API (Application Programming Interface) calls to a driver 11 for the GPU 2 that is executing on the CPU 1. The driver 11 then generates appropriate commands to cause the GPU 2 to render appropriate frames for display and to store those frames in appropriate frame buffers, e.g. in the main memory 6. The display processor 3 then reads the frames generated by the GPU 2 into a buffer for the display from where they are then read out and displayed on the display panel 7 of the display.

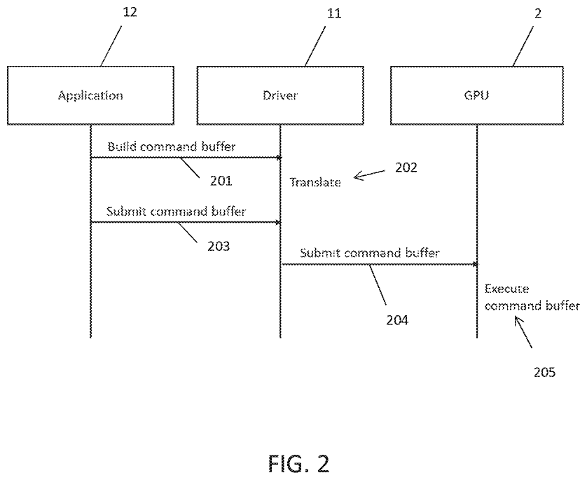

FIG. 2 illustrates schematically operation of the graphics processing system of FIG. 1 in more detail. As illustrated in FIG. 2, when application 12 requires processing operations to be performed by GPU 2, application 12 submits a sequence of API calls (a program) to GPU driver 11 (at step 201). In response, driver 11 just-in-time (JIT) compiles the API calls to a command buffer (program) for execution by GPU 2 (at step 202). The command buffer (compiled program) is then submitted to GPU 2 for execution (at steps 203 and 204), and GPU 2 then executes the command buffer (compiled program) provided by the driver 11 (at step 205).

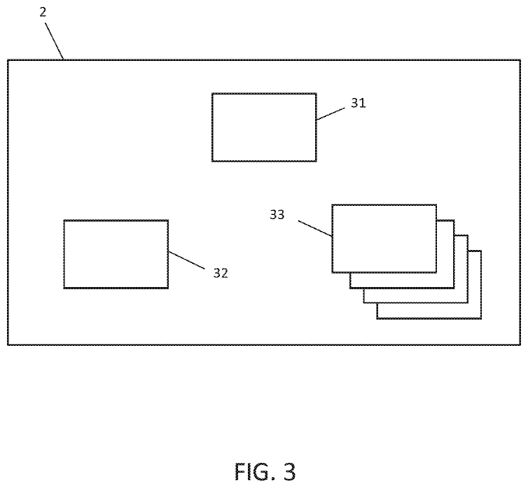

FIG. 3 schematically illustrates graphics processor (GPU) 2 in more detail. The graphics processor (GPU) 2 of FIG. 3 is a tile-based graphics processor that includes a command stream processor 31, a geometry processing unit 32, and a set of shader cores 33. Other arrangements are possible. For example, FIG. 3 shows four shader cores, but other numbers of shader cores are possible.

In use, command stream processor 31 receives and executes a command buffer (compiled program) provided by GPU driver 11, and may distribute subtasks to geometry processing unit 32 and shader cores 33 appropriately. For example, geometry processing unit 32 may perform geometry (e.g. tiling) processing operations, and shader cores 33 may perform a fragment processing pass that uses a result of the geometry processing performed by the geometry processing unit 32 to generate a render output (e.g. frame for display). Other arrangements are possible.

The command stream processor 31 is a CPU running firmware that interprets command buffer commands, and distributes tasks accordingly. Command stream processor 31 is thus an execution unit that executes GPU programs compiled by GPU driver 11.

To facilitate debugging of such GPU programs, it may be desirable to be able to implement breakpoints to pause execution of a program (command buffer) by GPU 2 and e.g. allow a debugger executing on CPU 1 to obtain appropriate debugging information. As GPU 2 will typically not have hardware support for breakpoints, breakpoints may be emulated in software. One way to do this is to use memory patching to cause exceptions that will be caught by the debugger. The inventor has found, however, that such arrangements can be expensive to implement and unreliable.

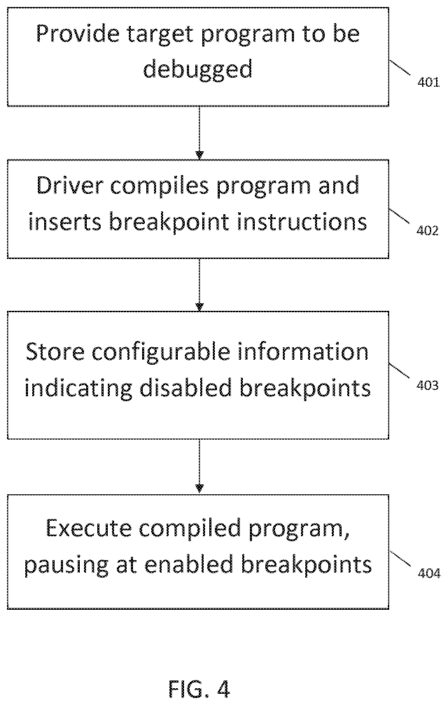

FIG. 4 shows an overview of a program debugging process in accordance with embodiments of the technology described herein. As illustrated in FIG. 4, an application 12 executing on CPU 1 provides GPU driver 11 with a target program for execution by (command stream processor 31 of) GPU 2 (at step 401). In response to receiving the target program, driver 11 compiles the target program for execution by (command stream processor 31 of) GPU 2, and inserts additional “potential breakpoint instructions” into the compiled target program at points in the target program where it could be desired to pause execution of the target program for debugging purposes (at step 402). In the present embodiments, these “potential breakpoint instructions” are defined and handled according to an ABI (Application Binary Interface).

Driver 11 may, for example, determine that a breakpoint could be desired at a place in the program having control flow, such as a jump, function call, before or inside a loop, before or after a branch, at synchronisation, etc. Additionally or alternatively, driver 11 may insert additional “potential breakpoint instructions” into the target program at regular intervals, such every N instructions (where N is a positive integer), or at places indicated in the source code, e.g. by a user (developer).

A user can then choose which of these “potential breakpoints” added to the target program should actually cause a pause in execution of the target program, and which of the “potential breakpoints” added to the target program should not actually cause a pause in execution of the target program. In other words, the user can select which “potential breakpoints” added to the program should be “actual breakpoints”, and which “potential breakpoints” added to the program should be “skipped over”. Information indicating this selection is stored (at step 403).

In the present embodiments, the stored “selection indicating information” is in the form of a user configurable array of bits that has the same number of bits as “potential breakpoints” added to the target program by the driver 11. A bit of the array of bits not being set (i.e. being zero) indicates that a corresponding “potential breakpoint” added to the target program should not cause a pause in execution of the target program (i.e. “skipped”), whereas a bit of the array of bits being set (i.e. being one) can indicate that a corresponding “potential breakpoint” added to the target program should cause a pause in execution of the target program (i.e. an “actual breakpoint”). Other arrangements are possible. For example, the selection of which “potential breakpoints” to enable/disable could be automated, and the selection indicating information could take a different form.

Then, when (command stream processor 31 of) GPU 2 executes the compiled target program, it will in response to a “potential breakpoint instruction” that has been added to the target program by driver 11, check the selection indicating information to determine whether or not to pause execution of the target program (at step 404). In the present embodiments, this check comprises checking whether a corresponding bit of the array of bits is not set (i.e. is zero) or is set (i.e. is one), which can be performed relatively quickly and with low overhead.

When it is determined not to pause execution of the target program, execution of the target program continues without pausing (i.e. a “potential breakpoint” is “skipped”). When it is determined to pause execution of the target program, execution of the target program by (command stream processor 31 of) GPU 2 is paused and control may be passed to a debugger program executing on CPU 1 for debugging purposes (i.e. a “potential breakpoint” is treated as an “actual breakpoint”).

Thus, by tightly coupling compile time and runtime operation, breakpoints can be implemented without needing to provide hardware support, and in a flexible, reliable and efficient manner.

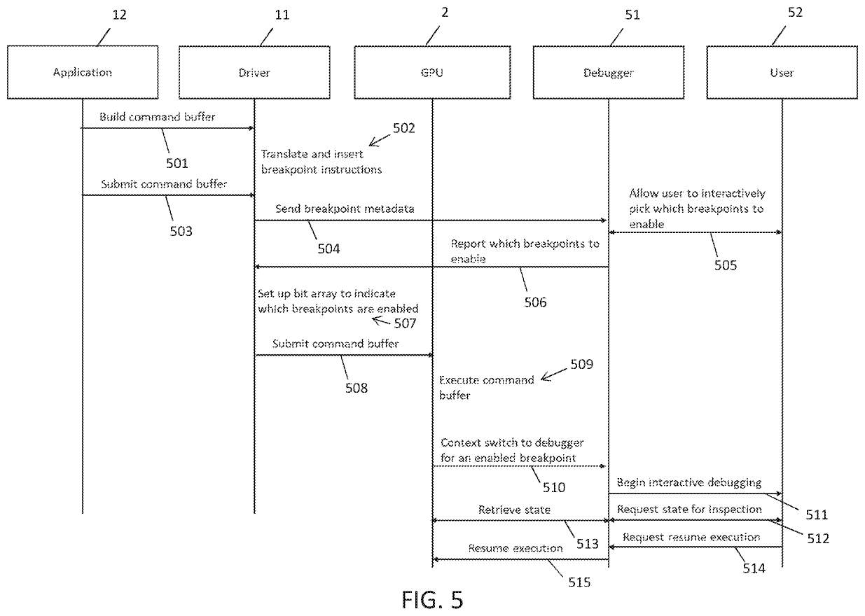

FIGS. 5 to 8 illustrate embodiments of the technology described herein in more detail.

FIG. 5 illustrates a program debugging process in accordance with embodiments of the technology described herein. As illustrated in FIG. 5, an application 12 executing on CPU 1 provides GPU driver 11 with a program for execution by GPU 2 that is being debugged (at step 501).

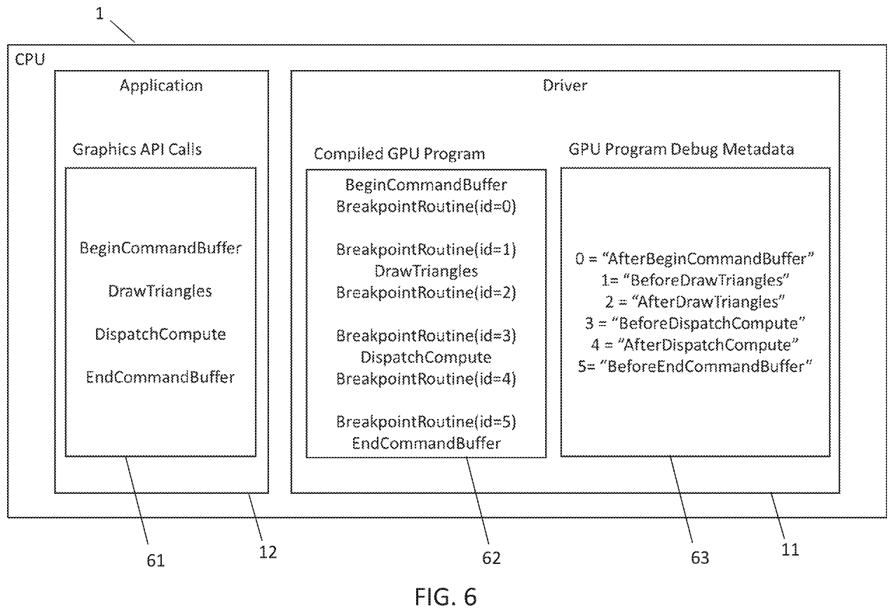

For example, FIG. 6 illustrates an exemplary program 61 that comprises a sequence of API calls which application 12 wants GPU 2 to execute.

Returning to FIG. 5, in response to receiving the program 61 that is being debugged, driver 11 just-in-time (JIT) compiles the program for execution by (command stream processor 31 of) GPU 2, and inserts additional “potential breakpoint instructions” in the compiled program at points in the program where a pause in execution (a breakpoint) could be desired by a user 52 for debugging purposes (at step 502).

For example, FIG. 6 illustrates a compiled program 62 in which driver 11 has added calls to the function “BreakpointRoutine” before and/or after each API call of the original program 61. FIG. 10 illustrates an exemplary pseudo-code definition of the “potential breakpoint” function “BreakpointRoutine”, which will be described below.

In the present embodiments, driver 11 assigns unique identifiers to the “potential breakpoint instructions” it adds to the program, and generates metadata describing the points in the program where the potential breakpoint instructions have been added. For example, as illustrated in FIG. 6, driver 11 associates each call to “BreakpointRoutine” that it adds to the program 62 with a unique identifier, id. In the present embodiments, the unique identifier, id, is an index starting at 0 and incrementing by 1 for each call to “BreakpointRoutine” added to the program, and is a parameter of the function “BreakpointRoutine”. Other arrangements are possible.

FIG. 6 also illustrates metadata 63 generated by the driver 11, which comprises respective text strings describing where each call to “BreakpointRoutine” is located in the program. Other arrangements are possible.

Returning to FIG. 5, in response to application 12 submitting the compiled program (command buffer) for execution (at step 503), driver 11 provides the metadata 63 to the debugger 51 that is executing on CPU 1 (at step 504), and in response, debugger 51 allows the user 52 to select which potential breakpoints to enable/disable (at step 505).

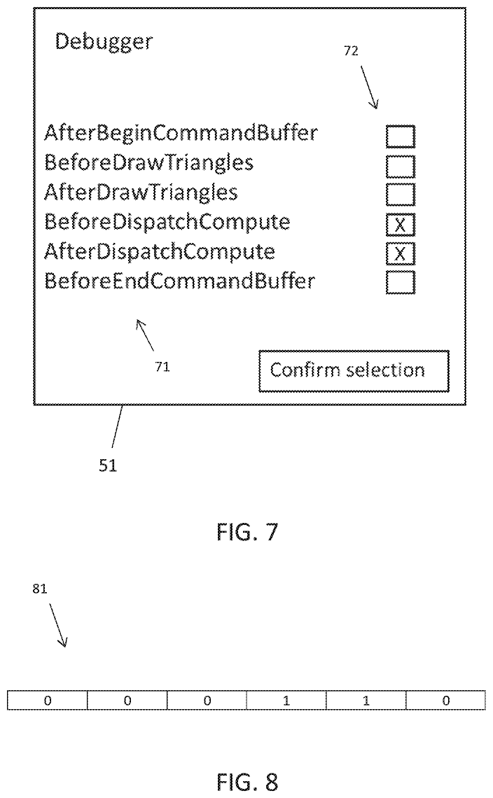

For example, FIG. 7 illustrates an exemplary graphical user interface (GUI) of debugger 51 in which the metadata text describing each potential breakpoint 71 is displayed to the user 52, together with associated checkboxes 72 that allow the user 52 to select where program execution should be paused or not. In the example illustrated by FIG. 7, the user 52 has decided that program execution should be paused before and after “DispatchCompute”, and has checked checkboxes 72 accordingly. Other arrangements are possible.

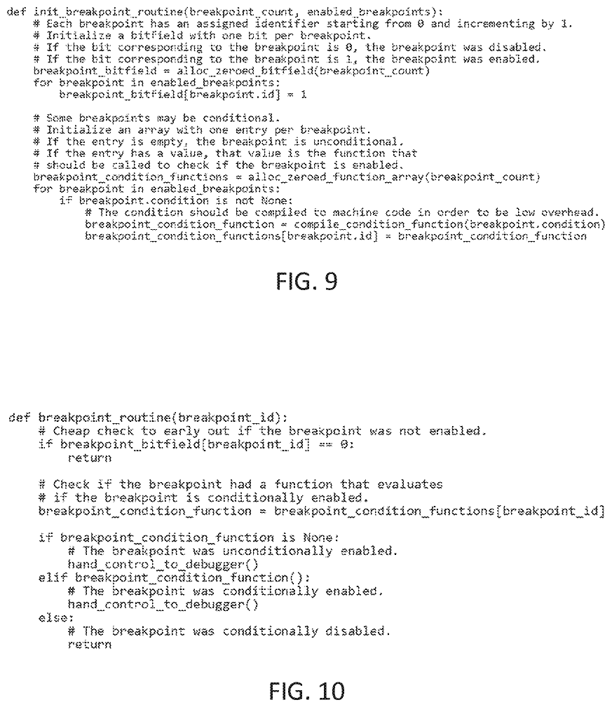

Returning to FIG. 5, debugger 51 returns information to driver 11 indicating the user's 52 selection of potential breakpoints (at step 506), and in response, driver 11 sets up an array of bits indicating which potential breakpoint instructions have and have not been selected (at step 507). FIG. 9 illustrates an exemplary pseudo-code definition of a function that may be used to set up the array of bits, which will be described below.

In the present embodiments, driver 11 generates an array of bits that has as many bits as number of calls to “BreakpointRoutine” added to the program. For example, FIG. 8 shows an exemplary bit array 81 set up by driver 11 that has six bits: one bit for each call to “BreakpointRoutine” added by the driver 11 to the program. As illustrated in FIG. 8, the first three bits of the bit array 81 are not set (i.e. are zero) to indicate that the first three calls to “BreakpointRoutine” added to the program should not result in a pause in program execution, the next two bits of the bit array 81 are set (i.e. are one) to indicate that the next two calls to “BreakpointRoutine” added to the program (i.e. before and after “DispatchCompute”) should result in a pause in program execution, and the last bit of the bit array 81 is not set (i.e. is zero) to indicate that the last call to “BreakpointRoutine” added to the program should not result in a pause in program execution. Other arrangements are possible.

Returning to FIG. 5, driver 11 then submits the compiled program (command buffer) to GPU 2 for execution (at step 508), and (command stream processor 31 of) GPU 2 executes the compiled program (at step 509). Then, when (command stream processor 31 of) GPU 2 executes the compiled program, it will in response to a potential breakpoint instruction that has been added to the program, check the array of bits 81 to determine whether or not to pause execution of the program. When it is determined to pause execution of the program, execution of the program by GPU 2 is paused and control is passed to debugger 51 (at step 510).

For example, when GPU 2 reaches the first call to “BreakpointRoutine” added to program 62, it will call the function “BreakpointRoutine” with parameter id=0, which will trigger a check of the first bit of bit array 81. As the first bit of bit array 81 is not set (i.e. is zero), it will be determined that execution of program 62 should continue without pausing, and so GPU 2 will move on to executing the next instruction in the program 62 without pausing. When GPU 2 reaches the fourth call to “BreakpointRoutine” added to program 62, however, it will call the function “BreakpointRoutine” with parameter id=3, which will trigger a check of the fourth bit of bit array 81. As the fourth bit of bit array 81 is set (i.e. is one), it will be determined that execution of program 62 should pause, and so execution of program 62 will be paused and control passed to debugger 51. Other arrangements are possible.

Returning to FIG. 5, when program execution is paused, debugger 51 may allow user 52 to perform debugging operations (at step 511), such as requesting program state information (at step 512) which may be provided to debugger 51 by GPU 2 (at step 513). When user 52 has completed debugging operations, user 52 may request resumption of program execution (at step 514) which triggers GPU 2 to resume program execution (at step 515). Other debugging operations, such as writing to a log, dumping data, etc., are possible.

Although in the above embodiments, program execution is paused in response to a bit of the bit array being set (i.e. being one), and is not paused in response to a bit of the bit array not being set (i.e. being zero), other arrangements are possible. For example, FIGS. 9 and 10 illustrate exemplary pseudo-code definitions for embodiments in which program execution may be paused based on whether one or more further conditions are satisfied.

As illustrated in FIG. 9, in these embodiments, an array of bits (“breakpoint_bitfield”) and an array defining one or more further conditions (“breakpoint_condition_function”) are generated (by driver 11) that each have the same number of entries as number of potential breakpoints (“breakpoint_count”) added to a program. The arrays are initialised with all elements being empty or zero, and then for each potential breakpoint that is not unconditionally disabled, the corresponding bit of the array of bits (“breakpoint_bitfield”) is set (i.e. to one), and for each potential breakpoint that is conditionally enabled, the corresponding element of the array “breakpoint_condition_function” is set to define one or more further conditions. In the present embodiments, the one or more further conditions are defined by one or more instructions which are just-in-time (JIT) compiled by diver 11 for execution by GPU 2.

As illustrated in FIG. 10, when “BreakpointRoutine” is called (by GPU 2), the array of bits (“breakpoint_bitfield”) is first checked to determine whether or not a corresponding bit is set. If the bit is not set (i.e. is zero), program execution continues, whereas if the bit is set (i.e. is one) control may be handed to the debugger unconditionally, or subject to one or more further conditions defined by “breakpoint_condition_function” being satisfied.

Although the above embodiments relate to implementing breakpoints in a GPU program that is compiled by a GPU driver and executed by a GPU, other arrangements are possible. For example, breakpoints may be implemented in a corresponding manner for other types of program and other types of data processors, such as a CPU, etc.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of debugging a program for execution by a data processor; the method comprising:
inserting, at one or more places in a program, a set of one or more instructions that when executed by the data processor, will cause the data processor to:
determine whether to pause execution of the program using information that indicates whether to continue executing the program without pausing; and
when it is determined to pause execution of the program, pause execution of the program;
the method further comprising:
the data processor executing the program, and in response to executing a set of one or more instructions inserted into the program:
determining whether to pause execution of the program using information that indicates whether to continue executing the program without pausing; and
when it is determined to pause execution of the program, pausing execution of the program.

2. The method of claim 1, comprising inserting the or each set of one or more instructions into the program when compiling the program for execution by the data processor.

3. The method of claim 1, wherein each set of one or more instructions comprises a call to the same function.

4. The method of claim 1, comprising determining one or more places in the program where a pause in execution of the program is likely to be suitable for debugging the program, and inserting a respective set of one or more instructions at the one or more determined places.

5. The method of claim 1, comprising allowing zero or more of one or more places at which a set of one or more instructions has been inserted to be selected, and configuring the information to indicate the selection.

6. The method of claim 1, wherein the information comprises one or more bits;
and wherein determining whether to pause execution of the program using the information comprises determining whether a bit of the one or more bits has a first value or a second value.

7. The method of claim 1, wherein the or each set of one or more instructions, when executed by the data processor, can cause the data processor to execute one or more further instructions to determine whether to pause execution of the program.

8. The method of claim 1, comprising the data processor:
when it is determined to pause execution of the program, pausing execution of the program and triggering one or more debugging operations.

9. A non-transitory computer readable storage medium storing software code which when executing on a processor performs the method of claim 1.

10. A method of debugging a program for execution by a data processor; the method comprising:
inserting, at one or more places in a program, a set of one or more instructions that when executed by the data processor, will cause the data processor to:
determine whether to pause execution of the program using information that indicates whether to continue executing the program without pausing; and
when it is determined to pause execution of the program, pause execution of the program for debugging the program.

11. A method of debugging a program for execution by a data processor; the method comprising:
the data processor executing a program, and in response to executing a set of one or more instructions inserted into the program:
determining whether to pause execution of the program using information that indicates whether to continue executing the program without pausing; and
when it is determined to pause execution of the program, pausing execution of the program for debugging the program.

12. A data processing system operable to debug programs; the data processing system comprising:
a processing circuit operable to provide programs for execution; and
a data processor operable to execute programs provided for execution by the processing circuit;
wherein the processing circuit is configured to:
insert, at one or more places in a program, a set of one or more instructions that when executed by the data processor, will cause the data processor to:
determine whether to pause execution of the program using information that indicates whether to continue executing the program without pausing; and
when it is determined to pause execution of the program, pause execution of the program; and
wherein the data processor is configured to, in response to executing a set of one or more instructions inserted into a program by the processing circuit:
determine whether to pause execution of the program using information that indicates whether to continue executing the program without pausing; and
when it is determined to pause execution of the program, pause execution of the program.

13. The data processing system of claim 12, wherein the processing circuit is configured to insert the or each set of one or more instructions into the program when compiling the program for execution by the data processor.

14. The data processing system of claim 12, wherein each set of one or more instructions comprises a call to the same function.

15. The data processing system of claim 12, wherein the processing circuit is configured to determine one or more places in the program where a pause in execution of the program is likely to be suitable for debugging the program, and insert a respective set of one or more instructions at the one or more determined places.

16. The data processing system of claim 12, wherein the processing circuit is configured to allow zero or more of one or more places at which a set of one or more instructions has been inserted to be selected, and to configure the information to indicate the selection.

17. The data processing system of claim 12, wherein the information comprises one or more bits; and wherein the data processor is configured to determine whether to pause execution of the program using the information by determining whether a bit of the one or more bits has a first value or a second value.

18. The data processing system of claim 12, wherein the or each set of one or more instructions, when executed by the data processor, can cause the data processor to execute one or more further instructions to determine whether to pause execution of the program.

19. The data processing system of claim 12, wherein the data processor is configured to:
when it is determined to pause execution of the program, pause execution of the program and trigger one or more debugging operations.

20. The data processing system of claim 12, wherein the data processor is a graphics processor.
